(19) United States
(12) Patent Application Publication
(10) Pub. No.: US 2025/0330740 A1
(43) Pub. Date: Oct. 23, 2025

(54) RAISED FEATURE ON EARBUD BODY

(71) Applicant: BOSE CORPORATION, Framingham, MA (US)

(72) Inventors: Allen T. GRAFF, Sutton, MA (US); Donna Marie SULLIVAN, Millbury, MA (US); Brian David BEAUDOIN, Medway, MA (US)

(21) Appl. No.: 18/639,281

(22) Filed: Apr. 18, 2024

(51) Int. Cl. H04R 1/10

(52) U.S. Cl. CPC H04R 1/105; H04R 1/1016; H04R 1/1066

(57) ABSTRACT

Aspects describe a retaining member of an in-ear audio output device to help stabilize and add comfort to a user wearing the device. Aspects describe a device comprising an earbud housing shaped to fit in a concha of an ear of a wearer of the device, and a body coupled to the earbud housing, the body extending away from an ear canal of the wearer and oriented outside of the ear when the device is worn, and a retention member comprising a leg that is curved to generally follow the curve of the anti-helix at the rear of the concha of a user's ear. The leg comprises a first segment, a second segment, and a web disposed between the first and second segments. The first and second segments have a greater thickness than the web.

### FIELD

Aspects of the present disclosure describe a retention member on an external surface of an earbud body. The member enables a more secure fit of the earbud in a user's ear. The placement of the member does not alter existing design features of the device providing user comfort, fit and portability.

### BACKGROUND

In-ear devices are small and designed to be comfortable and stable. Due to the size of the device and smooth surfaces of in-ear devices, users may have difficulty keeping the devices properly placed within their ears, especially when moving or being active. It is desirable to improve the stability and comfort of in-ear devices for a user.

### SUMMARY

Aspects describe a retaining member of an in-ear audio output device to help stabilize and add comfort to a user wearing the device. Aspects describe a device comprising an earbud housing shaped to fit in a concha of an ear of a wearer of the device, and a body coupled to the earbud housing, the body extending away from an ear canal of the wearer and oriented outside of the ear when the device is worn, and a retention member comprising a leg that is curved to generally follow the curve of the anti-helix at the rear of the concha of a user's ear. The leg comprises a first segment, a second segment, and a web disposed between the first and second segments. The first and second segments have a greater thickness than the web.

Aspects provide an in-ear audio output device, comprising: an earbud housing shaped to fit in a concha of an ear of a wearer of the device, a body coupled to the earbud housing, the body extending away from an ear canal of the wearer and oriented outside of the ear when the device is worn, and a retention member comprising a base configured to couple to the body, and a leg extending outwardly from the base, the leg comprising: a first segment, a second segment, wherein the first and second segments are curved to the shape of an anti-helix of a user's ear, an end opposite the base connecting the first segment to the second segment, the end being configured to fit under the anti-helix, and a web disposed in a central segment between the first segment and the second segment.

In aspects, wherein the first and second segments have a greater thickness than the web.

In aspects, wherein the web has a thickness of about 0.05 mm to about 0.4 mm, and the first and second segments each have a thickness of about 1 mm to about 4 mm.

In aspects, the web, the first and second segments, and the end each comprise a same material.

In aspects, the web is curved or serpentine in shape.

In aspects, the retention member is detachable.

In aspects, wherein the leg is disposed at an angle of about 0 degrees to about 45 degrees.

In aspects, the first segment has a greater length than the second segment.

In aspects, the leg extends outwardly from the base in a direction substantially perpendicular to the earbud housing.

Aspects provide in-ear audio output device comprising: an earbud housing shaped to fit in a concha of an ear of a wearer of the device, a body coupled to the earbud housing, the body extending away from an ear canal of the wearer and oriented outside of the ear when the device is worn, and at least one detachable retention member comprising a base configured to couple to the body, and a leg extending outwardly from the base, the leg comprising: a first segment, a second segment, wherein the first and second segments are curved to the shape of an anti-helix of a user's ear, an end opposite the base connecting the first segment to the second segment, the end being configured to fit under the anti-helix, and a web disposed in a central segment between the first segment and the second segment, the first and second segments having a greater thickness than the web.

In aspects, the at least one detachable retention member is two or more detachable retention members. In aspects, the leg of each of the two or more detachable retention members are different sizes.

In aspects, the web has a thickness of about 0.05 mm to about 0.4 mm, and the first and second segments each have a thickness of about 1 mm to about 4 mm.

In aspects, the web is curved or serpentine in shape.

In aspects, the leg is disposed at an angle of about 0 degrees to about 45 degrees.

Aspects provide an in-ear audio output device, comprising: an earbud housing shaped to fit in a concha of an ear of a wearer of the device, a body coupled to the earbud housing, the body extending away from an ear canal of the wearer and oriented outside of the ear when the device is worn, and two or more detachable retention members, each of the two or more detachable retention members individually comprising a base configured to couple to the body, and a leg extending outwardly from the base substantially perpendicular to the earbud housing, the leg comprising: a first segment, a second segment, wherein the first and second segments are curved to the shape of an anti-helix of a user's ear, an end opposite the base connecting the first segment to the second segment, the end being configured to fit under the anti-helix, a via disposed between the first and second segments, and a web disposed in the via, the first and second segments having a greater thickness than the web.

In aspects, the leg of each of the two or more detachable retention members are different sizes.

In aspects, the web has a thickness of about 0.05 mm to about 0.4 mm, and wherein the first and second segments each have a thickness of about 1 mm to about 4 mm.

In aspects, the web, the first and second segments, and the end each comprise a same material.

In aspects, the web is curved or serpentine in shape.

All examples and features mentioned herein can be combined in any technically possible manner. Other features, objects, and advantages will become apparent from the following detailed description, when read in connection with the following drawings.

### BRIEF DESCRIPTION OF THE DRAWINGS

FIG. 1 is a view of the lateral surface of the human ear.

FIGS. 2A-2C illustrate an in-ear audio output device for a user's right ear, according to one embodiment.

FIGS. 3A-3B illustrates a first design to the retention member of the device of FIGS. 2A-2C, according to one embodiment.

FIGS. 4A-4B illustrates a second design to the retention member of the device of FIGS. 2A-2C, according to another embodiment.

FIG. 5 illustrates a third design to the retention member of the device of FIGS. 2A-2C, according to yet another embodiment.

FIGS. 6A-6C illustrate various angles the retention member of the in-ear audio output device of FIGS. 2A-2C may be disposed at with respect to the body, according to various embodiments.

### DETAILED DESCRIPTION

In-ear audio output devices have become a prevalent part and convenient aspect of daily life. Some examples of such devices include audio headphones, hearing aids, hearing assistance headphones, noise-masking earbuds, and ANR headphones. In-ear devices allow hands-free listening, so that a user may listen to audio and/or block sound while doing something else. While working, people use in-ear devices to help concentrate and help avoid distracting others. Finally, in-ear devices are convenient while in transit or exercising due to their portability, wireless connectivity, and fit in a user's ear.

Given the small size of in-ear devices, the in-ear devices may become unstable or uncomfortable to a user, such as when the user is being active or when the in-ear devices fit improperly within the user's ears. It is desirable to improve the stability and comfort of in-ear devices for a user.

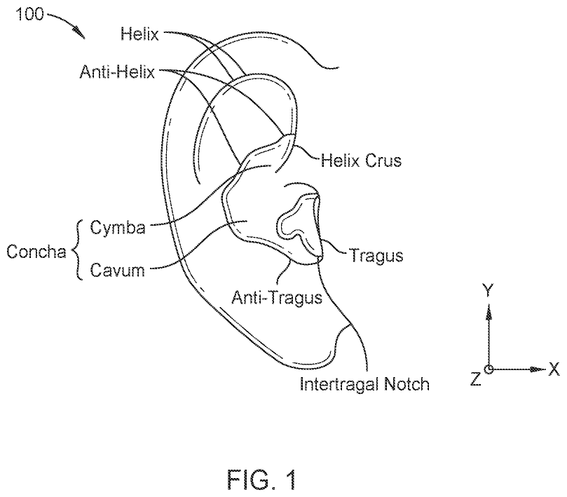

FIG. 1 shows the lateral surface of a human's right ear 100, with some features identified. There are many different ear sizes and geometries and include features not illustrated in FIG. 1. The in-ear audio output device described herein includes a body 212 that is coupled to an earbud housing 208. The body 212 is configured to sit outside the human ear and the housing 208 of the device is shaped to fit in the concha cavum.

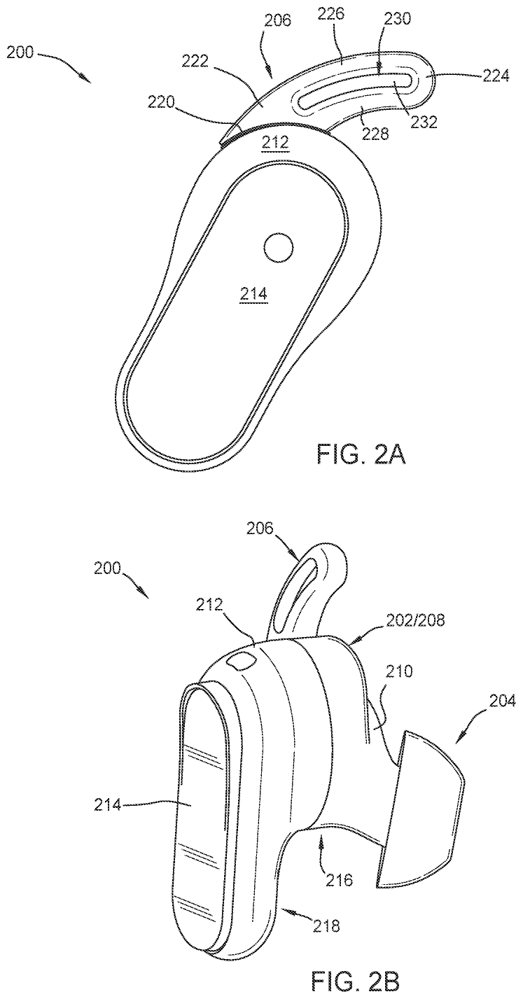

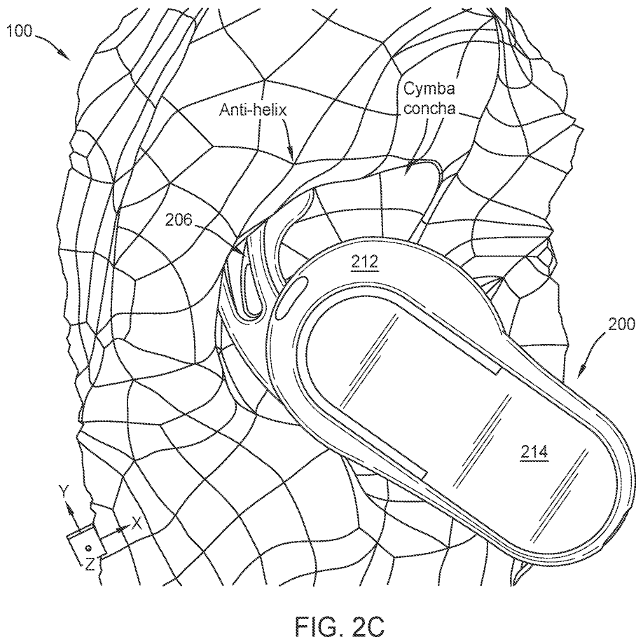

FIGS. 2A-2C illustrate an in-ear audio output device 200 for a user's right ear, according to one embodiment. A mirror-image of the design would be used for an earpiece for the left ear. FIG. 2A illustrates a back view of the device, FIG. 2B illustrates a side perspective view of the device 200, and FIG. 2C illustrates the device 200 disposed within a user's ear.

The device 200 includes an earbud 202, an ear tip 204, and a retention member 206. The earbud 202 includes a housing 208 having a first housing portion 210, a body 212, and a second housing portion (cap) 214 that together define an acoustic module 216 and an electronics module 218. The body 212 extends away from an ear canal of the user and is oriented outside the ear when the device 200 is worn. The ear tip 204 provides an acoustic seal with a user's ear when the earpiece 200 is used. The retaining piece 206 engages the user's anti-helix when the earpiece is worn to assist with retaining the earpiece in the user's ear. The retention member 206 may be angled between about 0 degrees to about 45 degrees, as discussed further below.

A base 220 of the retention member 206 is mechanically coupled to the body 212. In aspects, the retention member 206 is removable from the body 212. In further aspects described below, the device 200 may comprise one or more retention members 206, where the one or more retention members 206 each having different dimensions or sizes.

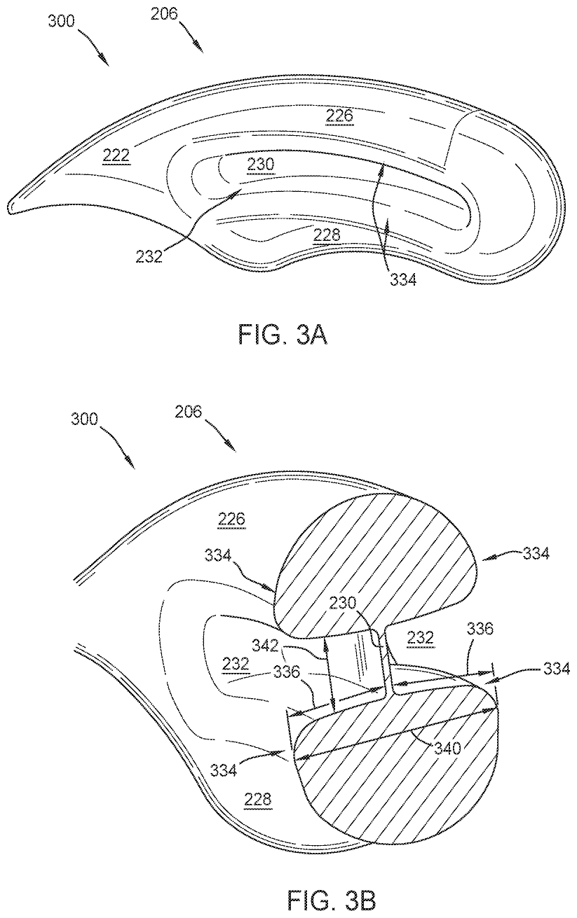

The retention member 206 comprises a leg 222 that is curved to generally follow the curve of the anti-helix at the rear of the concha of a user's ear, like shown in FIG. 2C. The leg 222 extends outwardly from the body 212. An end 224 of the leg 222 disposed opposite from the base 220 is configured to be wedged under the anti-helix in the cymba concha region and in contact with the base of the helix of the user's ear. The leg 222 extends outwardly from the base 212 in a direction substantially perpendicular to the earbud housing 208. The leg 222 comprises a first or upper segment 226, a second or lower segment 228, and a web 230 extending between a central segment of the first and second segments 226, 228. The web 230 disposed is within a recess or via 232 and such that the web 230 is centrally aligned within the central segment, as discussed further below in FIGS. 3A-5. The recess or via 232 may be referred to as two recess or vias 232, as the web 230 is centrally located between the first and second segments 226, 228, resulting in recesses or vias 232 being formed on each side of the web 230.

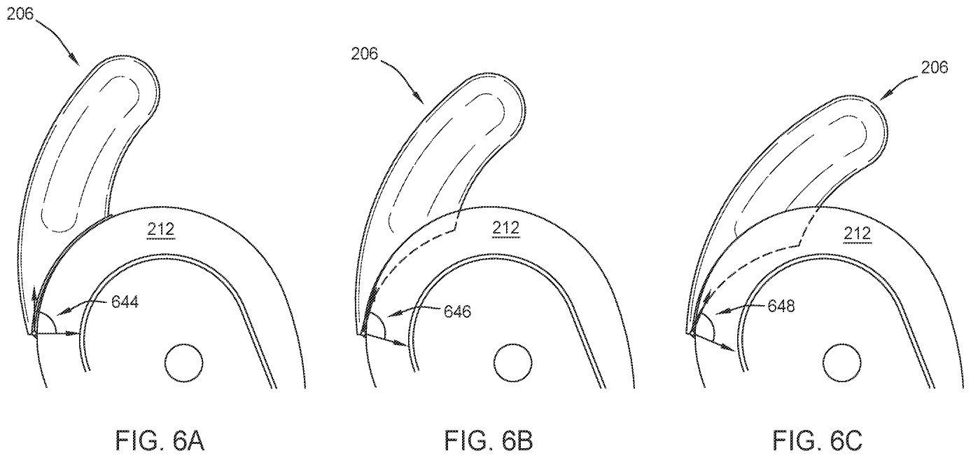

The first and second segments 226, 228 and the web 230 may all comprise the same material, such as silicon. The first and second segments 226, 228 each individually have a thickness of about 1 mm to about 4 mm. The web 230 has a thickness of about 0.05 mm to about 0.4 mm. Thus, the first and second segments 226, 228 have a greater thickness than the web 230. The web 230 may have a height extending from the first segment 226 to the second segment 228 of about 0.7 mm to about 2 mm. The leg 222 may be disposed at an angle of about 0 degrees to about 45 degrees with respect to the body 212, as described below in FIGS. 6A-6C. Due to the curvature of the leg 222, the first segment 226 may have a greater length extending from the base 220 to the end 224 opposite the base 220 than the second segment 228. For example, the first segment 226 may have a greater length than the second segment 228 by about 0 mm to about 2 mm.

The first segment 226 and the second segment 228 are substantially parallel, and help enable buckling of the leg 222, improving comfort for the user. The web 230 assists in adding stiffness to the leg 222, which provides additional stability of the device 200. The web 230 may be formed integrally with the first and second segments 226, 228 in a molding process. Forming the web 230 with the first and second segments 226, 228 prevents a ragged edge from forming on the first and second segments 226, 228 where flash molding might form during molding of the leg 222.

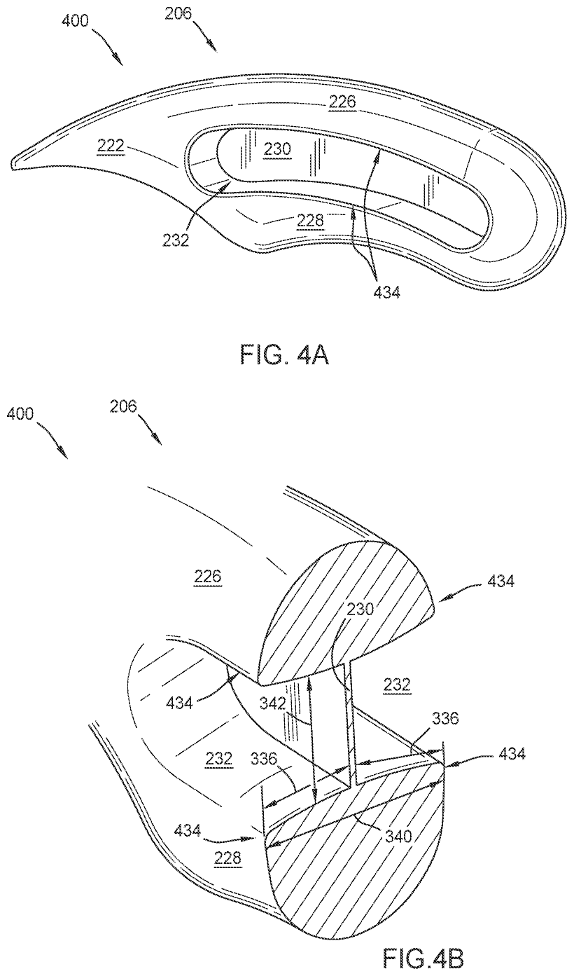

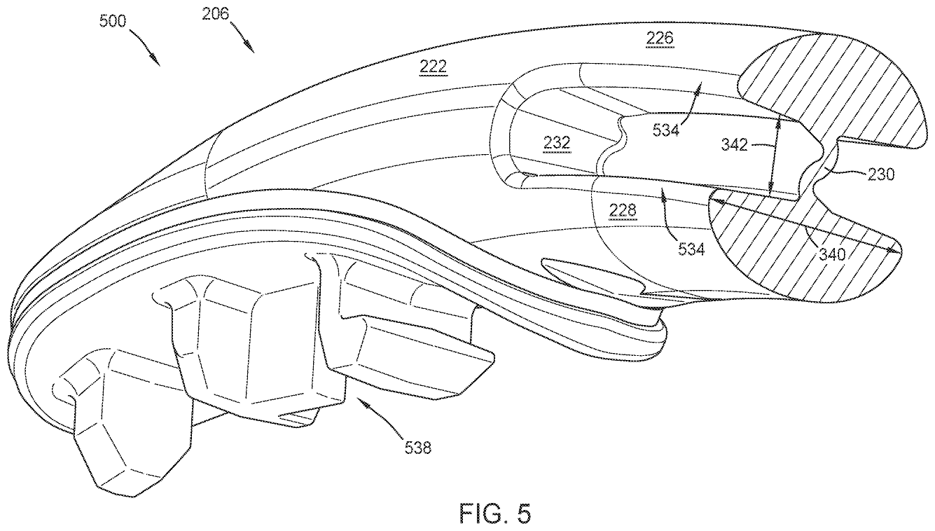

FIGS. 3A-5 illustrate various designs of retention members 206 of the in-ear audio output device 200 of FIGS. 2A-2C, according to various embodiments. FIGS. 3A-3B illustrate a first design 300 of the retention member 206, FIGS. 4A-4B illustrate a second design 400 of the retention member 206, and FIG. 5 illustrates a third design 500 of the retention member 206. Aspects of the first, second, and third designs 300, 400, 500 may be used in combination with one another. In aspects, a user may receive a retention member 206 of each of the first design 300, the second design 400, and the third design 500 to determine which design provides the most comfort and stability.

FIG. 3A illustrates a side perspective view of the first design 300, and FIG. 3B illustrates a cross-sectional view of the first design 300. In the first design 300, the edges 334 of the first and second segments 226, 228 disposed adjacent to the recess or vias 232 are rounded or curved inward towards the web 230. The curved edges 334 may be more comfortable for a user, as the curved edges 334 will not poke into the user's ear. In aspects, the web 230 is substantially flat or planar such that the length or height 342 runs vertically from the first segment 226 to the second segment 228. In other aspects, the web 230 may be curved, such as having an S-like shape, as discussed below in FIG. 5.

As shown in the cross-sectional view of FIG. 3B, the web 230 is centrally aligned between the first and second segments 226, 228 such that each recess or via 232 spans a depth 336 of about 0.5 mm to about 1.5 mm. The first and second segments 226, 228 each individually have a thickness 340 of about 1 mm to about 4 mm. The web 230 has a thickness of about 0.05 mm to about 0.4 mm. The web 230 may have a height 342 extending from the first segment 226 to the second segment 228 of about 0.7 mm to about 2 mm.

FIG. 4A illustrates a side perspective view of the second design 400, and FIG. 4B illustrates a cross-sectional view of the second design 400. In the second design 400, the edges 434 of the first and second segments 226, 228 disposed adjacent to the recess or vias 232 are tapered inwards towards the web 230. In some embodiments, the edges 434 may be squared. The tapered or squared edges 434 may enhance stability of the device 200. As shown in the cross-sectional view of FIG. 4B, the web 230 is centrally aligned between the first and second segments 226, 228 such that each recess or via 232 spans a depth 336 of about 0.5 mm to about 1.5 mm. In aspects, the web 230 is substantially flat or planar such that the length or height 342 runs vertically from the first segment 226 to the second segment 228. In other aspects, the web 230 may be curved, such as having an S-like shape, as discussed below in FIG. 5.

FIG. 5 illustrates a cross-sectional view of the third design 500. In the third design 500, the web 230 is curved or has an S-like or serpentine shape, which enables the web 230 to be thicker, such as about 0.05 mm to about 0.4 mm, without adding too much additional stiffness. The edges 534 of the first and second segments 226, 228 disposed adjacent to the vias 232 may be rounded, like described in FIGS. 3A-3B, or tapered or squared, like described in FIGS. 4A-4B. FIG. 5 further illustrates an attachment mechanism 538 that enables the retention member 206 to attach and detach from the base 212. Examples of the attachment mechanism 538 are described in co-pending patent application titled “In-Ear Earpiece Retaining Piece,” U.S. application Ser. No. 18/589,380, filed Feb. 27, 2024, assigned to the same assignee of this application, which is herein incorporated by reference.

FIGS. 6A-6C illustrate various angles the retention member 206 of the in-ear audio output device 200 of FIGS. 2A-2C may be disposed at with respect to the body 212, according to various embodiments. The retention member 206 of FIGS. 6A-6C may have one or more aspects of the first design 300 of FIGS. 3A-3B, the second design 400 of FIGS. 4A-4B, or the third design 500 of FIG. 5.

FIG. 6A illustrates the retention member 206 being disposed at a first angle 644 with respect to the body 212, where the first angle 644 is about 45 degrees. FIG. 6B illustrates the retention member 206 being disposed at a second angle 646 with respect to the body 212, where the second angle 646 is about 37 degrees. FIG. 6C illustrates the retention member 206 being disposed at a third angle 648 with respect to the body 212, where the third angle 648 is about 29 degrees. The retention members 206 of FIGS. 6A-6C may be individual retention members.

In aspects, a user may receive one or more individual retention members 206 disposed at each of the first angle 644, the second angle 646, and the third angle 648. Angling the retention member 206 at the various angles 644, 646, 648 enables a greater fit for various different ear sizes. For example, a user having a strongly curved anti-helix may find a retention member 206 having the third angle 648 to be the best fit, or a user having larger ears may find a retention member 206 having the first angle 644 to be the best fit.

Therefore, by including at least one retention member comprising a leg that is curved to generally follow the curve of the anti-helix at the rear of the concha of a user's ear, the leg comprising a first segment, a second segment, and a thin web disposed between the first and second segments in an in-ear audio output device, the device is able to provide both additional stability and comfort to a user. The first segment and the second segment help enable buckling of the leg, improving comfort for the user. The web assists in adding stiffness to the leg, which provides additional stability of the device. Furthermore, a user may receive two or more detachable retention members to enable the best and most comfortable fit.

Numerous uses of and departures from the specific apparatus and techniques disclosed herein may be made without departing from the inventive concepts. Consequently, the invention is to be construed as embracing each and every novel feature and novel combination of features disclosed herein.

1. An-ear audio output device, comprising:
an earbud housing shaped to fit in a concha of an ear of a wearer of the device;
a body coupled to the earbud housing, the body extending away from an ear canal of the wearer and oriented outside of the ear when the device is worn; and
a retention member comprising a base configured to couple to the body, and a leg extending outwardly from the base, the leg comprising:
a first segment;
a second segment, wherein the first and second segments are curved to the shape of an anti-helix of a user's ear;
an end opposite the base connecting the first segment to the second segment, the end being configured to fit under the anti-helix; and
a web disposed in a central segment between the first segment and the second segment.

2. The in-ear audio output device of claim 1, wherein the first and second segments have a greater thickness than the web.

3. The in-ear audio output device of claim 1, wherein the web has a thickness of about 0.05 mm to about 0.4 mm, and wherein the first and second segments each have a thickness of about 1 mm to about 4 mm.

4. The in-ear audio output device of claim 1, wherein the web, the first and second segments, and the end each comprise a same material.

5. The in-ear audio output device of claim 1, wherein the web is curved or serpentine in shape.

6. The in-ear audio output device of claim 1, wherein the retention member is detachable.

7. The in-ear audio output device of claim 1, wherein the leg is disposed at an angle of about 0 degrees to about 45 degrees.

8. The in-ear audio output device of claim 1, wherein the first segment has a greater length than the second segment.

9. The in-ear audio output device of claim 1, wherein the leg extends outwardly from the base in a direction substantially perpendicular to the earbud housing.

10. An-ear audio output device, comprising:
an earbud housing shaped to fit in a concha of an ear of a wearer of the device;
a body coupled to the earbud housing, the body extending away from an ear canal of the wearer and oriented outside of the ear when the device is worn; and
at least one detachable retention member comprising a base configured to couple to the body, and a leg extending outwardly from the base, the leg comprising:
a first segment;
a second segment, wherein the first and second segments are curved to the shape of an anti-helix of a user's ear;
an end opposite the base connecting the first segment to the second segment, the end being configured to fit under the anti-helix; and
a web disposed in a central segment between the first segment and the second segment, the first and second segments having a greater thickness than the web.

11. The in-ear audio output device of claim 10, wherein the at least one detachable retention member is two or more detachable retention members.

12. The in-ear audio output device of claim 11, wherein the leg of each of the two or more detachable retention members are different sizes.

13. The in-ear audio output device of claim 10, wherein the web has a thickness of about 0.05 mm to about 0.4 mm, and wherein the first and second segments each have a thickness of about 1 mm to about 4 mm.

14. The in-ear audio output device of claim 10, wherein the web is curved or serpentine in shape.

15. The in-ear audio output device of claim 10, wherein the leg is disposed at an angle of about 0 degrees to about 45 degrees.

16. An-ear audio output device, comprising:
an earbud housing shaped to fit in a concha of an ear of a wearer of the device;
a body coupled to the earbud housing, the body extending away from an ear canal of the wearer and oriented outside of the ear when the device is worn; and
two or more detachable retention members, each of the two or more detachable retention members individually comprising a base configured to couple to the body, and a leg extending outwardly from the base substantially perpendicular to the earbud housing, the leg comprising:
a first segment;
a second segment, wherein the first and second segments are curved to the shape of an anti-helix of a user's ear;
an end opposite the base connecting the first segment to the second segment, the end being configured to fit under the anti-helix;
a via disposed between the first and second segments; and
a web disposed in the via, the first and second segments having a greater thickness than the web.

17. The in-ear audio output device of claim 16, wherein the leg of each of the two or more detachable retention members are different sizes.

18. The in-ear audio output device of claim 16, wherein the web has a thickness of about 0.05 mm to about 0.4 mm, and wherein the first and second segments each have a thickness of about 1 mm to about 4 mm.

19. The in-ear audio output device of claim 16, wherein the web, the first and second segments, and the end each comprise a same material.

20. The in-ear audio output device of claim 16, wherein the web is curved or serpentine in shape.
